(19) United States
(12) Patent Application Publication
(10) Pub. No.: US 2006/0013284 A1
(43) Pub. Date: Jan. 19, 2006

(54) Phase stuffing spread spectrum technology modulation

(76) Inventor: Pierre Paul Guebels, Pleasanton, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 10/890,186

(22) Filed: Jul. 14, 2004

(51) Int. Cl. H04B 1/69

(52) U.S. Cl. 375/130

(57) ABSTRACT

A method of phase stuffing spread spectrum modulation by varying the frequency of an original clock in order to spread the peak energy content highly concentrated in the spectrum at a single original frequency. The spectral energy spreads around such original frequency thereby lowering its peak value. The time position of the clock rising edges are shifted by either stuffing or swallowing a variable time period in the clock waveform for each cycle. A phase interpolator accurately defines the candidate clock edges to be selected by a phase selector and phase controller. As a result, an electronic device utilizing the modulated clock output benefits from a much lower peak electromagnetic interference.

### BACKGROUND OF THE INVENTION

1. Field of the Invention

The present invention relates to spread spectrum modulation. More specifically, the present invention discloses a method of spread spectrum modulation utilizing phase stuffing spread spectrum technology modulation to reduce electromagnetic interference.

2. Description of the Prior Art

In addition to generating the desired electrical it is intended to, a frequency generator will also radiate electromagnetic waves over the frequency spectrum of the electrical signal it generates. These electromagnetic waves will have a frequency to which other devices may be sensitive. In this case, this may prevent these devices from functioning properly. Such electromagnetic emissions are considered electromagnetic interference (EMI). The higher the energy radiated by the signal, the worse the interference. EMI is therefore characterized by the energy radiated by the frequency source, usually in terms of the resulting electric field measured in dBμV/m at a given frequency.

Electromagnetic interferences are subject to very strict regulations by the United States Federal Communications Commission (FCC) and other international regulatory bodies. These regulations aim at limiting the amount of EMI electronic devices emit, preventing interference between electronic devices, and preventing possible damage to the human body.

Frequency synthesizers, crystal oscillators, clock signal generation integrated circuits, although essential to the proper performance of many electronic devices, are the principal sources of EMI in electronic circuitry. EMI reduction is therefore a major issue for designers of electronic devices that use components generating frequency and clock signals.

While conventional EMI reduction methods such as shielding, special coating, filtering components, etc. are common practice, the tightness of EMI regulations and the cost sensitivity of their impact have led to the search for alternative and less expensive solutions.

Therefore there is need for an improved method of spread spectrum modulation utilizing a phase stuffing spread spectrum technology modulator which reduces EMI at lower cost.

### SUMMARY OF THE INVENTION

To achieve these and other advantages and in order to overcome the disadvantages of the conventional method in accordance with the purpose of the invention as embodied and broadly described herein, the present invention provides a method of spread spectrum modulation utilizing phase stuffing spread spectrum technology modulation to reduce EMI.

It is important to note that EMI emissions will be generated over the entire frequency spectrum of the signal causing the EMI. Therefore, when considering the EMI emissions over a given frequency spectrum, one may distinguish peak emissions from average emissions. Peak emissions are defined as the highest dBμV/m level reached over the frequency spectrum of the signal, while average emissions are defined as the average dBμV/m level radiated over the frequency spectrum of the signal.

In terms of EMI, existing regulations are essentially concerned about preventing interference at any given frequency. Therefore, regulatory bodies limit peak emissions, rather than average emissions.

For a given signal source, the radiated energy or EMI emission is concentrated within the frequency spectrum of the signal. Seen from another angle, this means that if the power of the signal is kept constant, the peak emissions will be reduced whenever the frequency spectrum of the signal can be spread across a broader bandwidth. The application of this principle is called spread spectrum.

Spread Spectrum Modulation (SSM) consists of varying the frequency of an original perfect clock in order to spread the peak energy content that is highly concentrated in the spectrum at the single original frequency. The spectral energy then spreads around such original frequency thereby lowering its peak value.

Frequency Modulation is one approach to SSM. Another approach is phase stuffing SST modulator (PSSM). PSSM implements consistent and systematic phase modulation using digital edge processing.

PSSM is finite and periodic as it corresponds to typical periodic and centered SST modulation waveforms. Synthesized clock waveforms are usually squared in shape and their phase information fixes the time position of the clock waveform's rising and falling edges. By processing the time position of such rising edges provides implementation of any type of finite periodic phase modulation. PSSM shifts the time position of the clock rising edges by stuffing or swallowing a variable time period in the clock waveform for each of its cycles. Stuffing and swallowing is done in discrete unit of time under control of a finite state machine in an orderly manner approximating the requested continuous phase modulation. The digital processing of clock edges requires a phase interpolator to accurately define the candidate clock edges to be selected.

PSSM is a digital technique robust against manufacturing defects. PSSM tracks the original clock frequency such that the SST modulation is independent of it. Additionally, PSSM is flexible to allow application in a large class of applications. The only requirements are small modulation index, centered and periodic FM modulation.

In application, an original clock signal is input and a modulated version of the clock is output. To build the output clock with processed clock edges, the candidate rising time edge positions which will be selected by a Phase Controller and Phase Selector need to be created first.

A Phase Interpolator generates a plurality of phases of the original clock each shifted by a fixed time unit tau=T/(2ˆN). N is a design parameter that is set according to the application requirements such as percent modulation range, acceptable jitter levels, and acceptable spurs in the output clock.

The Phase Selector is a digital circuit that will move the clock phase selection by a small unit from the presently selected phases. If the selected phase is increased (stuffing or positive slip) the output clock period is increased. If the selected phase is decreased (swallowing or negative slip) the output clock period is decreased.

Because the modulation has to follow a given modulation pattern, the phase increment will have to follow a given order to reflect such modulation. The dedicated processor for the purpose is the Phase Controller, which is implemented as a full arithmetic unit of a finite state machine, or simply a ROM in function of the complexity of the modulation waveform.

By varying the frequency of the original clock the peak energy content highly concentrated in the spectrum at a single original frequency is spread. The spectral energy spreads around such original frequency thereby lowering its peak value. As a result, an electronic device utilizing the phase spread spectrum technology modulation of the present invention benefits from a much lower peak electromagnetic interference.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a drawing illustrating a waveform of an unmodulated clock;

FIG. 2 is a drawing illustrating possible clock phases;

FIG. 3 is a block diagram illustrating a spread spectrum technology modulator according to an embodiment of the present invention;

FIG. 4 is a block diagram illustrating a phase stuffing spread spectrum technology modulator according to an embodiment of the present invention;

FIG. 5 is a block diagram of an embodiment utilizing filtered modulation;

FIG. 6 is a block diagram of an embodiment utilizing feedback filtering;

FIG. 7 is a block diagram of an embodiment utilizing unfiltered modulation;

FIG. 8 is a graph illustrating percent (r) versus r;

FIG. 9 is a graph illustrating m(t) versus t;

FIG. 10 is a graph illustrating

$$\frac{ϕ ( t )}{2 \cdot π}$$

versus t;

FIG. 11 is a graph illustrating δₖ versus k;

FIG. 12 is a graph illustrating

$$\frac{ϕ ( {tr}_{k} )}{2 \cdot π}$$

versus k;

FIG. 13 is a graph illustrating nk versus k;

FIG. 14 is a graph illustrating

$$\frac{\frac{{F}_{k}}{2 \cdot π}}{\frac{ϕ ( {tr}_{k} )}{2 \cdot π}}$$

versus k; and

FIG. 15 is a graph illustrating

$$\frac{{F}_{k} - ϕ ( {tr}_{k} )}{ϕ ( {tr}_{\frac{N}{2}} )}$$

versus k.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

Following is an outline of the basic principle of the present invention.

The calculations for modulation m(t) are as follows:

$$f ( t ) is the frequency and ϕ ( t ) is the phase deviation \\ m ( t ) is periodic of period Tm ; m ( t + Tm ) = m ( t ) \\ m ( t ) is centered ; {\int }_{t + 0}^{t + Tm} m ( u ) ⅆ u = 0 \\ \frac{f ( t ) - fo}{fo} = \frac{1}{2 π fo} \frac{ⅆ}{ⅆ t} ϕ ( t ) = \frac{T}{2 π} \frac{ⅆ}{ⅆ t} ϕ ( t ) \\ \frac{f ( t ) - fo}{fo} = m ( t )$$

$$\frac{ⅆ}{ⅆ t} ( ϕ ( t ) ) = \frac{2 π}{T} \cdot m ( t )$$

$$ϕ ( t ) = \frac{2 π}{T} {\int }_{{t}_{o}}^{t} m ( u ) ⅆ u$$

$$With m ( {t}_{o} ) = 0$$

$$ϕ ( {t}_{o} ) = ϕ ( {t}_{o} + Tm ) = 0$$

Therefore φ(t) is defined once m(t) is given.

$$2 π fot + ϕ ( t ) = k \cdot 2 π ;$$

$${t}_{k} + \frac{ϕ ( {t}_{k} )}{2 π fo} = k \cdot fo ;$$

$${t}_{k + 1} + \frac{ϕ ( {t}_{k + 1 } )}{2 π fo} = \frac{( k + 1 )}{fo} ;$$

$$( {t}_{k + 1} - {t}_{k} ) + \frac{T}{2 π} ( ϕ ( {t}_{k + 1} ) - ϕ ( {t}_{k} ) ) = T ;$$

$${t}_{k + 1} - {t}_{k} = T - \frac{T}{2 π} ( ϕ ( {t}_{k + 1} ) - ϕ ( {t}_{k} ) ) ;$$

$$ϕ ( t ) = \frac{2 π}{T} {\int }_{{t}_{o}}^{t} m ( u ) ⅆ u = T - ( {\int }_{{t}_{o}}^{{t}_{k + 1}} m ( u ) ⅆ u - {\int }_{{t}_{o}}^{{t}_{k}} m ( w ) ⅆ u ) ;$$

Therefore,

$$ϕ ( t ) = T - {\int }_{{t}_{k}}^{{t}_{k + 1}} m ( u ) ⅆ u ;$$

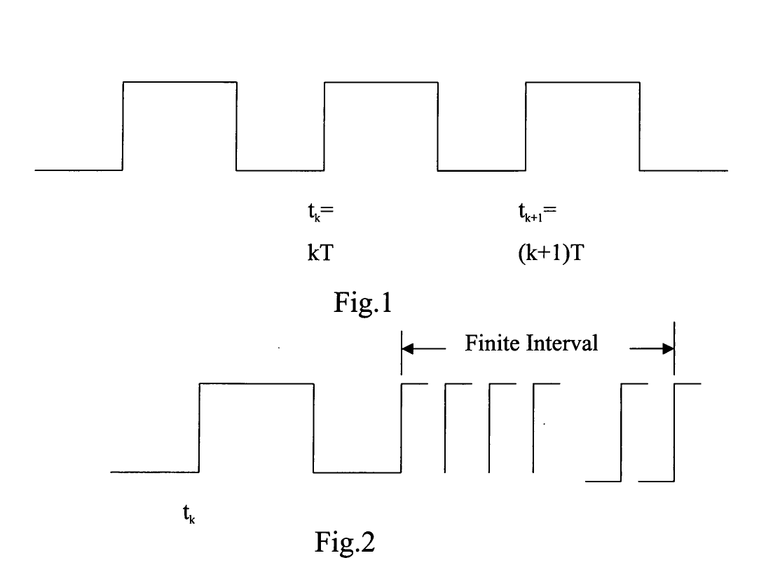

Refer to FIG. 1, which is a drawing illustrating a waveform of an unmodulated clock.

The rising edges of an unmodulated digital clock occurs at time tₖ such that 2πf₀t=k·2π or tₖ=kT.

For all k; tₖ₊₁−tₖ=T

Spread spectrum modulation transforms this into

$${t}_{k + 1} - {t}_{k} = T - {\int }_{{t}_{k}}^{{t}_{k + 1}} m ( u ) ⅆ u ;$$

The modulation m(t) being known (periodic and centered).

Refer to FIG. 2, which is a drawing illustrating possible clock phases.

This shows at every cycle the next rising edge has to be selected from a set of possible clock phases.

In application, the principle described above can be implemented in digital circuitry.

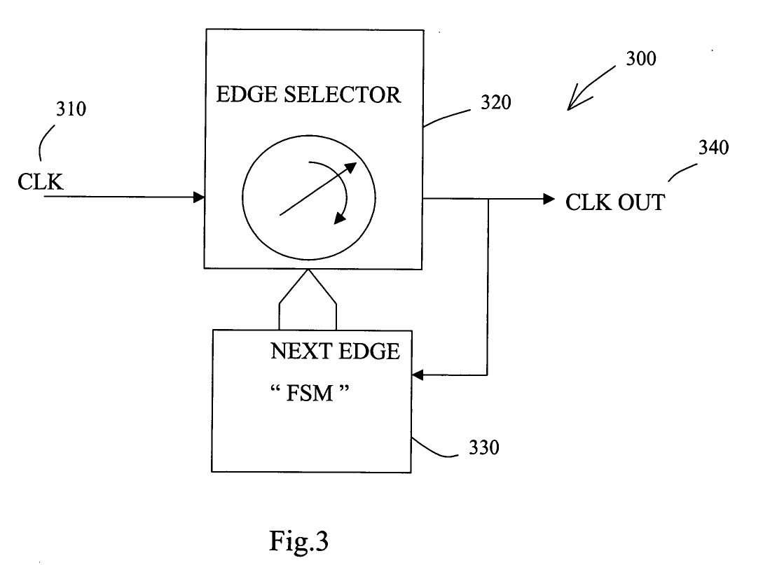

Refer to FIG. 3 which is a block diagram illustrating a spread spectrum technology modulator according to an embodiment of the present invention.

As shown in FIG. 3, the spread spectrum technology modulator 300 comprises an edge selector 320 and a next edge finite state machine 330. The original clock signal is CLK 310. The modulated output clock is CLKOUT 340. The original clock signal 310 is fed into an edge selector 320. Because the modulation follows a given modulation pattern, the phase increment follows a given order to reflect such modulation. In order to achieve this a dedicated processor is utilized. In the embodiment shown in FIG. 3, a next edge Finite State Machine (FSM) 330 is used. However, other devices such as a read only memory (ROM) could be used.

The FSM 330 comprises a look-up table storing stuffing or swallowing values. SST modulation is specified in terms of profile and associated parameters for example, triangular modulation, 0.5% peak modulation (f0*0.995 to f0*1.005) and modulation rate of 33 KHz. Note that these values are given as way of example. The actual values can be selected to meet requirements. These parameters provide the frequency function of time f(t), and integration delivers the phase function of time phi(t). A discrete approximation of phi(t) is obtained in terms of accumulated stuffing or swallowing n(k). It is these n(k) which are stored in the look-up table.

Therefore, utilizing the edge selector 320 in conjunction with the next edge FSM 330, the modulated CLKOUT 340 is achieved.

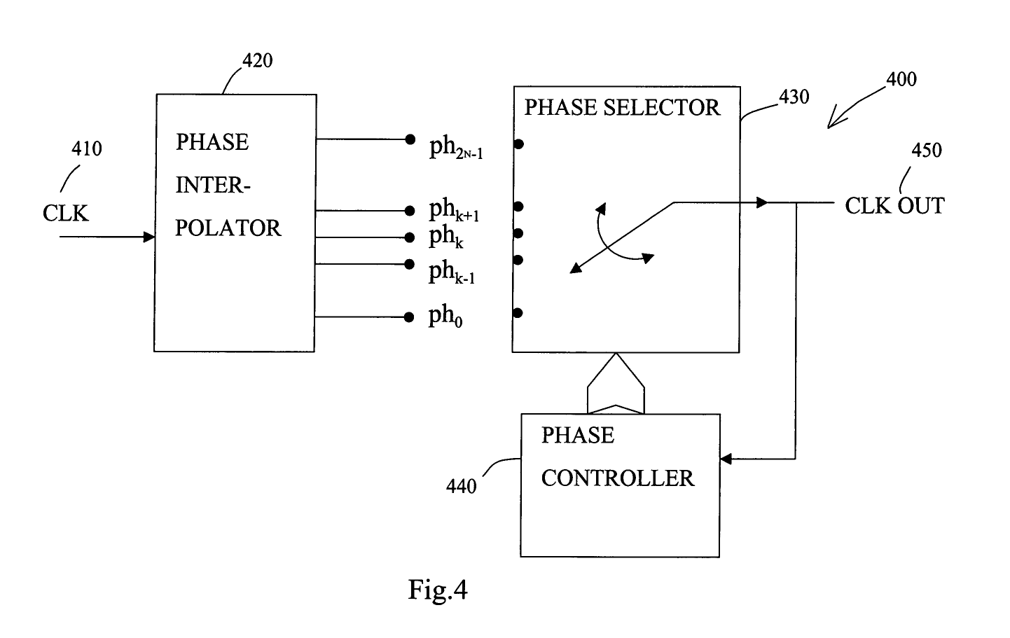

Refer to FIG. 4, which is a block diagram illustrating a phase stuffing spread spectrum technology modulator according to an embodiment of the present invention.

As shown in FIG. 4, the phase stuffing spread spectrum technology modulator 400 comprises a phase interpolator 420, a phase selector 430, and a phase controller 440.

CLK 410 is the original clock input and CLKOUT 450 is the modulated version.

To build CLKOUT 450 with processed clock edges, the candidate rising time edge positions which will be selected by the phase controller 440 and phase selector 430 blocks need to be created first.

The Phase Interpolator 420 block generates 0, 1, . . . , 2ˆN−1 phases of the original clock CLK 410 each shifted by a fixed time unit tau=T/(2ˆN). N is a design parameter that is set according to the application requirements such as percent modulation range, acceptable jitter levels, and acceptable spurs in CLKOUT 450. N is usually an integer number between 5 . . . 8. It should be noted that the 2ˆN phases do not need to be available at the same time, but only the one in the neighborhood of the last selected phase needs to be generated. For example, if N=8 it would only be about 5 out of the 256 phases. The reason for this is that usual modulations within a cycle of the clock are by very small index (%/a factor). Phase Octant selection is used and interpolation is within each Octant.

The Phase Selector 430 is a digital circuit that will move the clock phase selection by a small unit from the presently selected phases. If the selected phase is increased (stuffing or positive slip) the CLKOUT 450 period is increased. If the selected phase is decreased (swallowing or negative slip) the CLKOUT 450 period is decreased.

Because the modulation has to follow a given modulation pattern, the phase increment will have to follow a given order to reflect such modulation. The dedicated processor for the purpose is the Phase Controller 440 block that is implemented as a full arithmetic unit of a finite state machine or simply a ROM in function of the complexity of the modulation waveform.

As with the embodiment of the present invention as illustrated in FIG. 3, the embodiment shown in FIG. 4 also discloses SST modulation which is specified in term of profile and associate parameters, for example, Triangular modulation, 0.5% peak modulation (f0*0.995 to f0*1.005 and modulation rate of 33 Khz. This provides the frequency function of time f(t), integration delivers the phase function of time φ(t). Then a discrete approximation of φ(t) is obtained in terms of accumulated stuffing or swallowing n(k). It is these n(k) which are stored in the ROM look-up table or Phase Controller.

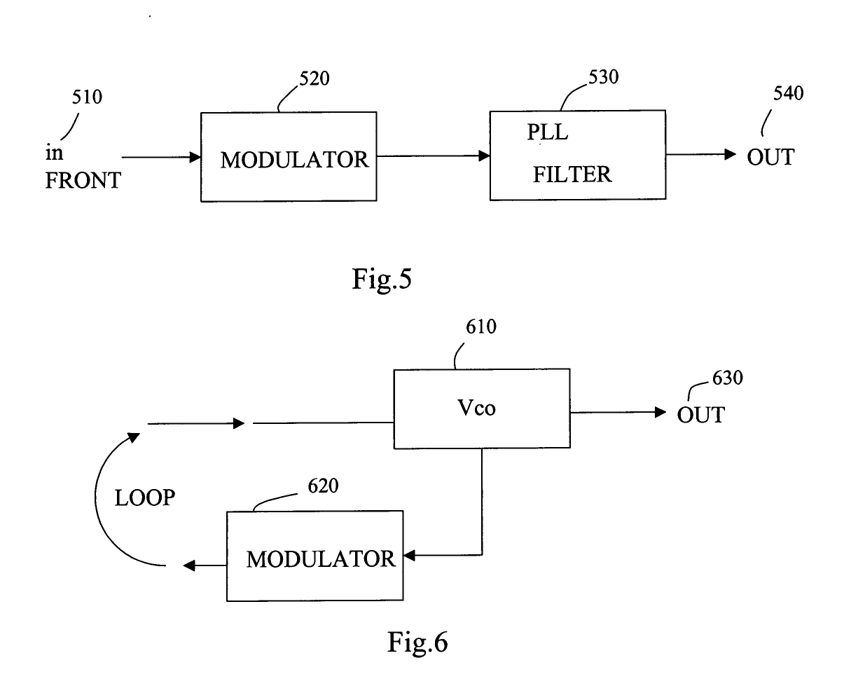

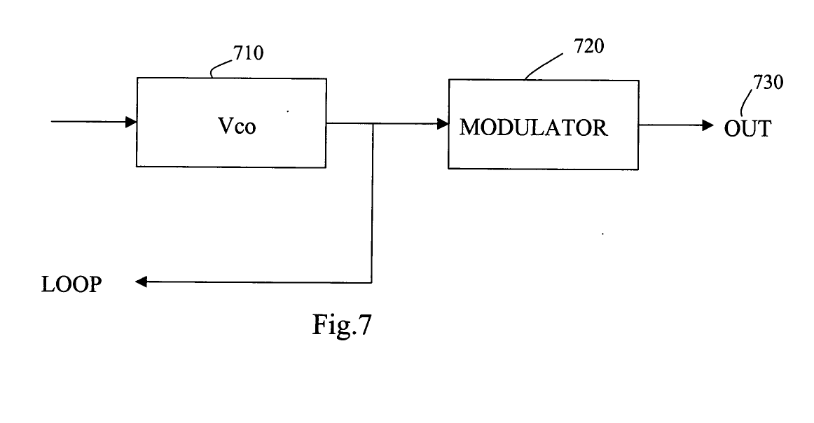

Refer to FIG. 5, which is a block diagram of an embodiment utilizing filtered modulation, FIG. 6, which is a block diagram of an embodiment utilizing feedback filtering, and FIG. 7, which is a block diagram of an embodiment utilizing unfiltered modulation.

A phase locked loop can be used to filter the discrete phase jumps occurring at each stuffing or swallowing. The modulated clock can be either the REF clock of the filtering PLL (front filtering) as illustrated in FIG. 5, or the modulator can be embedded in the phase locked loop feedback path (feedback filtering) as illustrated in FIG. 6. In both cases the PLL output provides a filtered version of the discretely modulated clock. Alternately, an unfiltered modulated clock is provided by the embodiment illustrated in FIG. 7.

As shown in FIG. 5, the clock in 510 on the front end is modulated by a modulator 520 and then filtered by a PLL filter 530 and output 540.

Alternatively, as shown in FIG. 6, the modulator 620 is in the phase locked loop feedback path. A voltage controlled oscillator VCO 610 provides the clock output 630.

For an unfiltered modulated clock as shown in FIG. 7, the VCO 710 provides the reference clock which is then modulated by the modulator 720 and then output 730.

The following calculations and analysis are given as an example of a method for SST modulation based on phase interpolation and the generation of the stuffing values.

VCO period:
f0:=400.0·10⁶ T0:=1/f0 T0=2.5×10⁻⁹ kstuff:=1

Interpolator granularity:

$$k := 5 τ = \frac{T0}{{2}^{k}} τ = 7.8125 \times {10}^{- 11}$$

acceptable added jitter.

For a case of a single k_stuffing every r time.

$$percent ( r ) := {10}^{2} \cdot \frac{\frac{kstuff}{r \cdot {2}^{k}}}{1 + \frac{kstuff}{r \cdot {2}^{k}}}$$

in absolute value.

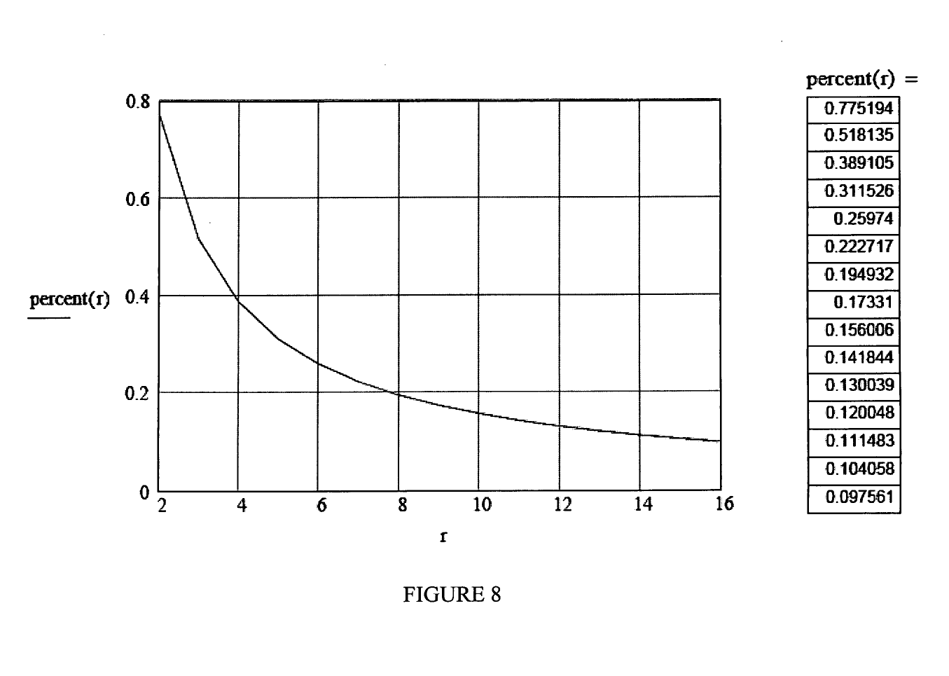

Refer to FIG. 8, which is a graph illustration peak values according to an embodiment of the present invention. As shown in FIG. 8, the peak value should be feasible: r:=2 . . . 16.
Ds:=16 Phase Updates (stretch or contract) only occur once per Ds period of the VCO.

$$\begin{matrix}fup := \frac{f0}{Ds} & Tup := \frac{1}{fup} & Tup = 4 {x10}^{- 8} Update Frequency \\ fm := ( \frac{30.0 + 33.0}{2} ) \cdot {10}^{3} & Tm := \frac{1}{fm} & Tm = 3.174603 \times {10}^{- 5} Modulation\end{matrix}$$

Frequency

$$φ ( t ) = φ ( t0 ) + 2 \cdot π \cdot f0 \cdot ( t - t0 ) + 2 \cdot π \cdot f0 \cdot {\int }_{t0}^{t} m ( u ) ⅆ u$$

$$f ( t ) = f0 \cdot ( 1 + m ( t ) )$$

$$Assume \text{:} \begin{matrix}φ ( t0 ) = 0 & t0 = 0\end{matrix}$$

$$φ ( t ) = 2 \cdot π \cdot f0 \cdot t + 2 \cdot π \cdot f0 \cdot {\int }_{t0}^{t} m ( u ) ⅆ u$$

$$f ( t ) = \frac{1}{2 π} \cdot \frac{ⅆ}{ⅆ t} φ ( t )$$

$$ϕ ( t ) = φ ( t ) - 2 \cdot π \cdot f0 \cdot t$$

$$\begin{matrix}Define \text{:} & φ ( {tr}_{k} ) = k \cdot 2 \cdot π & Rising Edge at Ds rate \\ & ϕ ( t ) = \frac{2 \cdot π}{T0} \cdot {\int }_{0}^{t} m ( u ) ⅆ u & \end{matrix}$$

$$\begin{matrix}2 \cdot π f0 \cdot {tr}_{k} + ϕ ( {tr}_{k} ) - k \cdot 2 \cdot π \cdot Ds = 0 & {tr}_{k} = k \cdot Ds \cdot T0 - To \cdot \frac{ϕ ( {tr}_{k} )}{2 \cdot π} \\ Tup = Ds \cdot T0 & \end{matrix}$$

Phase interpolation will be by rising edge clock adjustment

$$( {tr}_{k} - {tr}_{k - 1} ) - T0 = - T0 \cdot \frac{ϕ ( {tr}_{k} ) - ϕ ( {tr}_{k - 1} )}{2 \cdot π} = - {\int }_{{tr}_{k - 1}}^{{tr}_{k}} m ( u ) ⅆ u$$

$$Center Spread with x := 0.012 \qquad Δ f := \frac{x}{2} \cdot f0 \qquad Δ f = 2.4 {x10}^{6}$$

Δf is the peak frequency deviation

$$mod u ( t ) := 2 \cdot x \cdot \frac{t}{Tm}$$

Base modulation waveform. t>=0.

To allow for a reduced ROM memory in the implementation some reasonable constraints are enforced on the modulation waveform.

$$\begin{matrix}m ( t ) := t ← mod ( t , Tm ) & Periodic with period Tm . \\ 0 if ( t = 0 ) ⋁ ( t = \frac{Tm}{2} ) & Single value at t \text{-} intervals boundaries \\ \frac{x}{2} if t = \frac{Tm}{4} & \\ - \frac{x}{2} if t = 3 \cdot \frac{Tm}{4} & \\ mod u ( t ) if 0 < t < \frac{Tm}{4} & Quadrantal Symmetry\end{matrix}$$

$$mod u ( \frac{Tm}{2} - t ) if \frac{Tm}{4} < t < \frac{Tm}{2} \\ - mod u ( t - \frac{Tm}{2} ) if \frac{Tm}{2} < t < 3 \cdot \frac{Tm}{4} \\ - mod u ( Tm - t ) if 3 \cdot \frac{Tm}{4} < t < Tm$$

$$i mod u ( t ) := \frac{2 \cdot π}{T0} \cdot x \cdot \frac{{t}^{2}}{Tm}$$

Integral of the modulation function including the phase conversion factor. t>=0.

$$\begin{matrix}ϕ ( t ) := & t ← mod ( t , TM ) \\ & i mod u ( t ) if 0 < t , \frac{Tm}{4} \\ & 2 \cdot i mod u ( \frac{Tm}{4} ) - i mod u ( \frac{Tm}{2} - t ) if \frac{Tm}{4} < t < \frac{Tm}{2} \\ & 2 \cdot i mod u ( \frac{Tm}{4} ) - i mod u ( t - \frac{Tm}{2} ) if \frac{Tm}{2} < t < 3 \cdot \frac{Tm}{4} \\ & i mod u ( Tm - t ) if 3 \cdot \frac{Tm}{4} < t < Tm\end{matrix}$$

Further one synchronizes the modulation frequency with the update frequency when sampling the modulation waveform.

$$\begin{matrix}N := round ( \frac{\frac{Tm}{4}}{Tup} ) \cdot 4 & N = 792 & \frac{N}{4} = 198 \\ Tm := N \cdot Tup & fm := \frac{1}{Tm} & fm = 3.156566 \times {10}^{4}\end{matrix}$$

$$Tm = 3.168 \times {10}^{- 5}$$

$$t := 0 , \frac{Tm}{N} … Tm$$

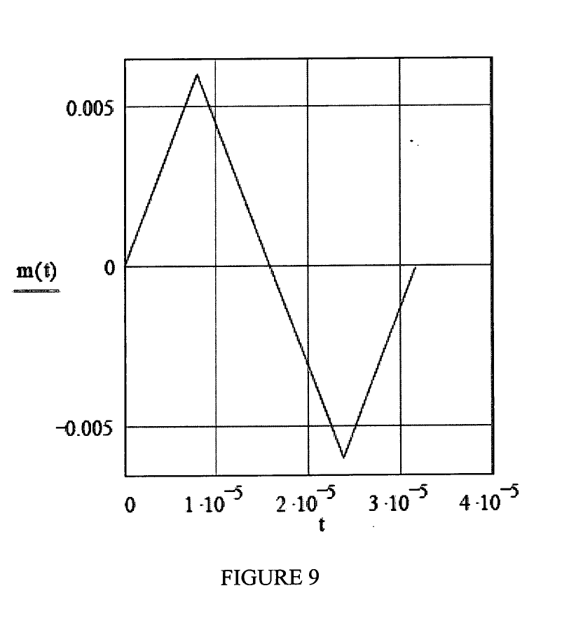

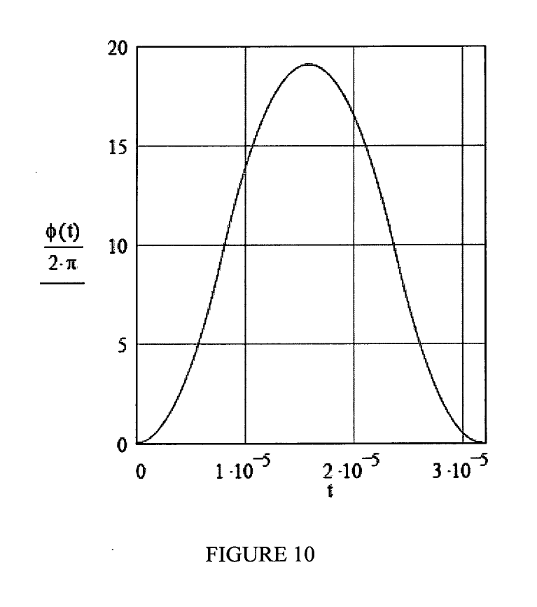

Refer to FIG. 9, which is a graph illustrating m(t) versus t, and to FIG. 10, which is a graph illustrating

$$\frac{ϕ ( t )}{2 \cdot π}$$

versus t.

Exact rising edge times induced by the modulation:

$$N = 792 \qquad {tr}_{k} = k \cdot Tup - T0 \cdot \frac{ϕ ( {tr}_{k} )}{2 \cdot π} \qquad {tr}_{0} := 0 \qquad Rising edges once$$

$$every Ds edges of T0 . \\ k := 1 … N$$

$${tr}_{k} := root [ \begin{matrix}y - k \cdot Tup + T0 \cdot \frac{ϕ ( y )}{2 \cdot π} , \\ y , {tr}_{k - 1} + Tup \cdot ( 1 - x ) , {tr}_{k - 1} + Tup \cdot ( 1 + x )\end{matrix} ]$$

$$δ k := - Tup \cdot \frac{ϕ ( {tr}_{k} ) - ϕ ( {tr}_{k - 1} )}{2 \cdot π} \qquad k := 0 … N$$

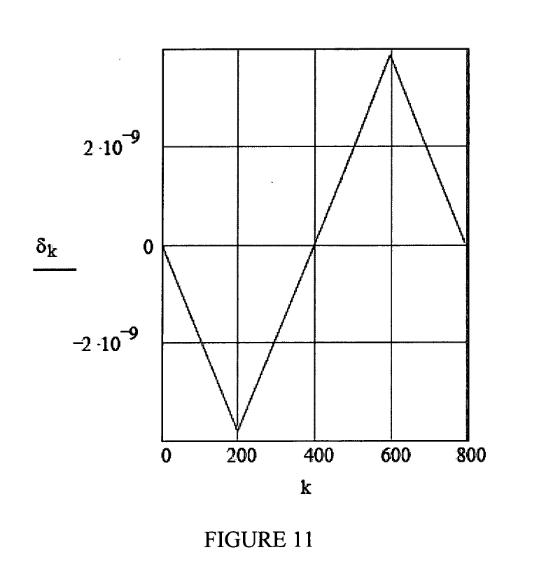

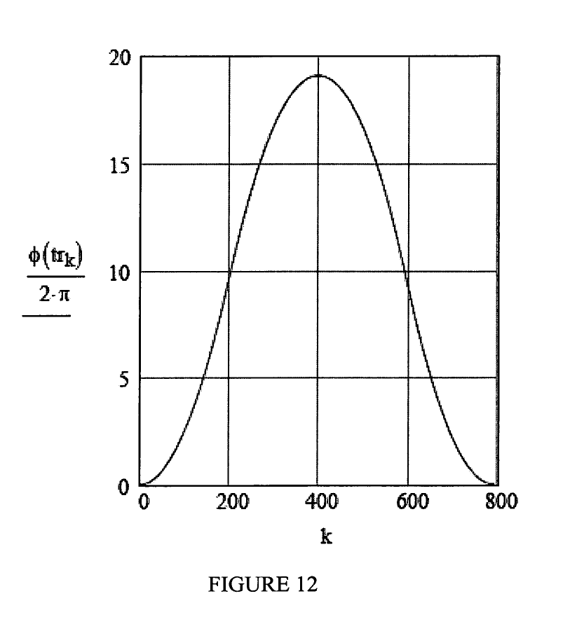

Refer to FIG. 11, which is a graph illustrating δₖ versus k, and to FIG. 12, which is a graph illustrating

$$\frac{ϕ ( {tr}_{k} )}{2 \cdot π}$$

versus k.

The generated edges (clock phases) have to track at best the ideal rising edges via the stuffing nk:

$$\begin{matrix}{tr}_{k} = {tr}_{k - 1} + Tup - T0 \cdot \frac{ϕ ( {tr}_{k} ) - ϕ ( {tr}_{k - 1} )}{2 \cdot π} & {tr}_{0} = 0 \\ {tg}_{k} = {tg}_{k - 1} + Tup + {n}_{k} \cdot τ & {tg}_{0} = 0\end{matrix}$$

$${F}_{k} = {F}_{k - 1} + \frac{2 \cdot π}{T0} \cdot [ Tup - ( {tg}_{k} - {tg}_{k - 1} ) ]$$

$${tg}_{k} := 0 \qquad {n}_{0} := 0 \qquad {F}_{0} := 0$$

$$k := 1 … N$$

$${tg}_{k} := {tg}_{k - 1} + Tup + round ( \frac{{tr}_{k} - {tg}_{k - 1} - Tup}{τ} ) \cdot τ$$

$${n}_{k} := round ( \frac{{tr}_{k} - {tg}_{k - 1} - Tup}{τ} )$$

$${F}_{k} := {F}_{k - 1} + \frac{2 \cdot π}{T0} \cdot [ Tup - ( {tg}_{k} - {tg}_{k - 1} ) ]$$

$$k := 0 … N$$

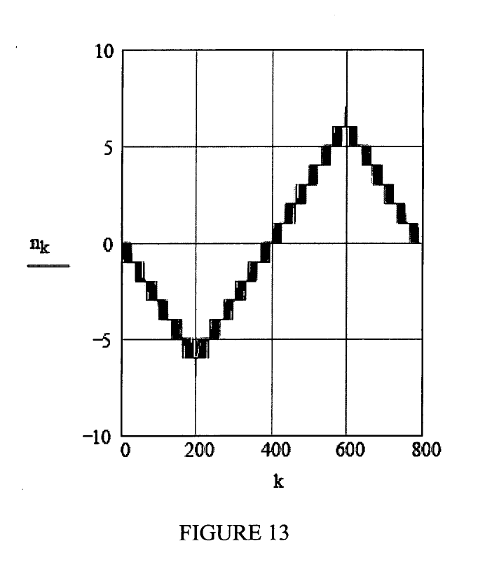

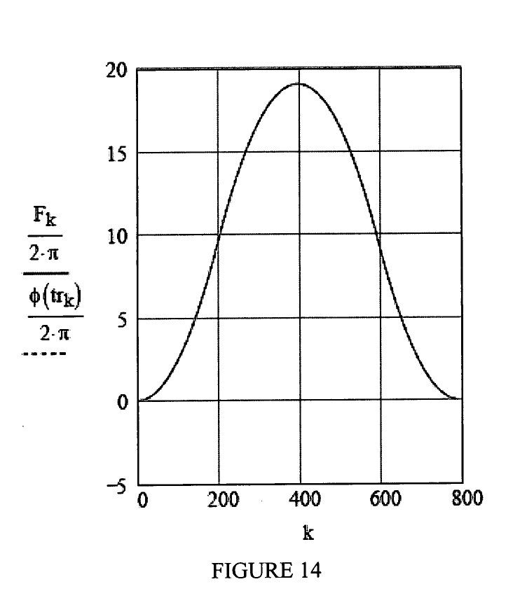

Refer to FIG. 13, which is a graph illustrating nk versus k, to FIG. 14, which is a graph illustrating

$$\frac{\frac{{F}_{k}}{2 \cdot π}}{\frac{ϕ ( {tr}_{k} )}{2 \cdot π}}$$

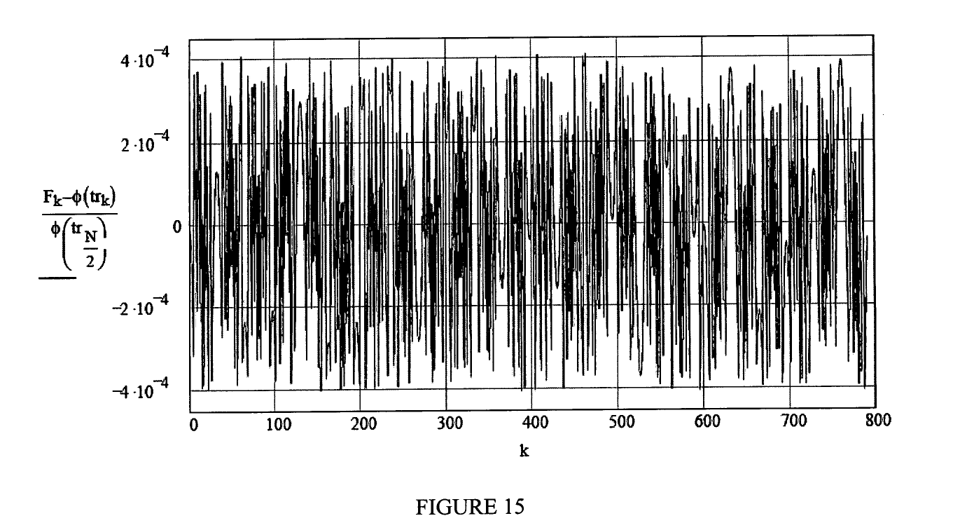

versus k, and to FIG. 15, which is a graph illustrating

$$\frac{{F}_{k} - ϕ ( {tr}_{k} )}{ϕ ( {tr}_{\frac{N}{2}} )}$$

versus k.

Utilizing the phase stuffing spread spectrum modulation method of the present invention offers numerous benefits and advantages. PSSM is a digital technique robust against manufacturing defects. PSSM tracks the original clock frequency such that the SST modulation is independent of it. And PSSM is flexible to allow a large class of applications.

Therefore, the present invention provides a method of phase stuffing spread spectrum modulation by varying the frequency of an original clock in order to spread the peak energy content highly concentrated in the spectrum at a single original frequency. The spectral energy spreads around such original frequency thereby lowering its peak value. As a result, an electronic device utilizing the phase spread spectrum technology modulation of the present invention benefits from a much lower peak electromagnetic interference.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A method of spread spectrum modulation comprising:
varying frequency of a clock signal to spread peak energy; and
shifting time position of rising edges of the clock signal by stuffing or swallowing a variable time period of a clock cycle.

2. The method of spread spectrum modulation of claim 1, wherein stuffing a variable time period of a clock cycle increases a period of the clock.

3. The method of spread spectrum modulation of claim 1, wherein swallowing a variable time period of a clock cycle decreases a period of the clock.

4. The method of spread spectrum modulation of claim 1, further comprising:
outputting the shifted rising edges to form a modulated version of the clock signal.

5. A method of spread spectrum modulation comprising:
inputting an original clock signal with a fixed period;
generating a plurality of phases of the original clock signal;
selecting a phase from the plurality of phases;
whereby the phase increases or decreases the original clock signal period;
repeatedly selecting another phase to generate a modulated clock signal; and
outputting the modulated clock signal.

6. The method of spread spectrum modulation of claim 5 further comprising;
storing and recalling modulation parameters in a phase controller.

7. The method of spread spectrum modulation of claim 6 wherein the modulation parameters comprise; modulation type, peak modulation percentage, modulation rate, frequency function of time, phase function of time, stuffing parameters, swallowing parameters, or a combination of these.

8. The method of spread spectrum modulation of claim 6, wherein the phase controller comprises a finite state machine, a read only memory, a look-up table, or an arithmetic unit.

9. The method of spread spectrum modulation of claim 5, wherein the plurality of phases are generated by a phase interpolator.

10. The method of spread spectrum modulation of claim 9, wherein the phase interpolator utilizes phase octant selection and interpolates within each octant to generate the plurality of phases.

11. The method of spread spectrum modulation of claim 5, further comprising:
filtering the modulated clock signal.

12. The method of spread spectrum modulation of claim 11, wherein a phase locked loop is utilized to filter the modulated clock signal.

13. The method of spread spectrum modulation of claim 11, wherein the filtering is front filtered or feedback filtered.

14. A method of spread spectrum modulation comprising:
storing modulation parameters in a phase controller;
inputting an original clock signal with a fixed period into a phase interpolator;
generating a plurality of phases of the original clock signal by the phase interpolator;
selecting a phase from the plurality of phases by a phase selector based at least in part on the modulation parameters in the phase controller;
whereby the phase increases or decreases the original clock signal period;
repeatedly selecting another phase by the phase selector in order to generate a modulated clock signal; and
outputting the modulated clock signal.

15. The method of spread spectrum modulation of claim 14 wherein the modulation parameters comprise; modulation type, peak modulation percentage, modulation rate, frequency function of time, phase function of time, stuffing parameters, swallowing parameters, or a combination of these.

16. The method of spread spectrum modulation of claim 14, wherein the phase controller comprises a finite state machine, a read only memory, a look-up table, or an arithmetic unit.

17. The method of spread spectrum modulation of claim 14, wherein the phase interpolator utilizes phase octant selection and interpolates within each octant to generate the plurality of phases.

18. The method of spread spectrum modulation of claim 14, further comprising:
filtering the modulated clock signal.

19. The method of spread spectrum modulation of claim 18, wherein a phase locked loop is utilized to filter the modulated clock signal.

20. The method of spread spectrum modulation of claim 18, wherein the filtering is front filtered or feedback filtered.
